(19) United States
(12) Patent Application Publication
(10) Pub. No.: US 2006/0182134 A1
(43) Pub. Date: Aug. 17, 2006

(54) System and method for dissimilar handoffs in a SONET system

(75) Inventors: Jorey M. Pascasio JR., San Antonio, TX (US); Richard G. Jankins, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P, Reno, NV (US)

(21) Appl. No.: 11/056,937

(22) Filed: Feb. 11, 2005

(51) Int. Cl. H04J 3/16

(52) U.S. Cl. 370/404; 370/466

(57) ABSTRACT

A system and method are disclosed for transporting data including a first add drop multiplexer (ADM) configured to receive non Time Division Multiplexing (non-TDM) traffic and to encapsulate the non-TDM traffic as an embedded payload within a SONET synchronous transport signal (STS) frame. A first synchronous optical network (SONET) ring may be coupled to the first ADM and an optical cross connect module may at least partially interconnect the first SONET ring and a second SONET ring. The optical cross connect module may be configured to pass the SONET STS frame, having an embedded non-TDM data as a payload, to the second SONET ring without de-encapsulating the non-TDM traffic from the SONET STS frame. The ADM may be capable of converting data formats that comply with Open System Interconnection (OSI) layers 2, 3, and 4 into an STS format. While non-TDM traffic elements may include, for example, Ethernet frames, Internet Protocol packets, an Asynchronous Transfer Mode (ATM) frame and a Fibre channel frame, the handoff between SONET rings may be accomplished utilizing routing information contained within the STS frame.

### FIELD OF THE INVENTION

The present disclosure relates generally to telecommunication systems and more specifically to a system and method for moving data over synchronous optical networks.

### BACKGROUND

The demand for faster, more efficient data communications over long distances continues to increase. The main portion of an intercontinental or long distance communication system is commonly referred to as a “backbone.” A backbone is a high-speed network typically operated by larger telecommunications companies and is a major component of what we know as the “Internet.” The amount of data traveling over the Internet continues to increase, and communication companies continue to struggle in an effort to provide an increase in capacity without having to add additional infrastructure. Additional infrastructure may consist of physical lines being laid in the earth and expensive equipment coupled to these new lines for processing and routing information. Adding infrastructure is very expensive.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 depicts a block diagram of a data transport system for providing dissimilar handoffs in accordance with the teachings disclosed herein; and

FIG. 2 shows a flow diagram that illustrates a method of processing non-TDM data in a SONET system.

### DETAILED DESCRIPTION OF THE DRAWINGS

A system and method are disclosed for transporting data between SONET rings. An example system may include, for example, a first add drop multiplexer (ADM) configured to receive non Time Division Multiplexing (non-TDM) traffic and to encapsulate the non-TDM traffic as an embedded payload within a SONET synchronous transport signal (STS) frame. A first synchronous optical network (SONET) ring may be coupled to the first ADM and an optical cross connect module may at least partially interconnect the first SONET ring and a second SONET ring. In some embodiments, the optical cross connect module may be configured to pass the SONET STS frame, having an embedded non-TDM data as a payload, to the second SONET ring without de-encapsulating the non-TDM traffic from the SONET STS frame. The ADM may also be configured to convert data formats complying with Open System Interconnection (OSI) layers 2, 3, and 4 into an STS format. As such, non-TDM traffic elements can include Ethernet frames, Internet Protocol packets, an Asynchronous Transfer Mode (ATM) frame, a Fibre channel frame, and/or some other formatting of data. Depending upon implementation detail, the handoff between SONET rings may be accomplished such that information contained within a given STS frame is utilized to help route the frame.

As indicated above, adding capacity to a backbone can be expensive. Another way to help increase the communication performance and capacity of a backbone is to provide more efficient transfer of the data. In certain regions of the United States, interconnected Synchronous Optical Networks (SONETs) transport vast quantities of data between large metropolitan areas, such as from Cleveland, Ohio to Detroit, Mich. In accordance with the teachings disclosed herein, such SONET rings may utilize time division multiplexing (TDM) techniques, such as a synchronous transport system (STS) to facilitate the routing and transporting of non-TDM data. For example, an Ethernet packet may be encapsulated into the payload portion of an STS formatted frame for communication between SONET rings.

Though Ethernet is mentioned above, there may be many other communication protocols such as Fibre channel, IP, and Asynchronous Transfer Mode (ATM) that can be transported using techniques other than Time Division Multiplexing. When SONET transmissions containing non-TDM formats move from one SONET system to another, inefficiencies may be encountered. Data that is purely of the STS type can be efficiently transferred between SONET systems, however, non-STS data may need to be “unbundled” or “de-encapsulated” and/or returned to its non-TDM format when passing between SONET rings, because the routing information must be accessed.

As such, in SONET systems data may be bundled prior to entering a first ring, unbundled when it exists the ring, and bundled again in order to travel to its destination over a second SONET ring. Data may traverse multiple SONET systems and this conversion process must occur at every transition. When the non-TDM data reaches its destination it once again is unbundled.

Bundling, un-bundling, re-bundling and re-unbundling is often a very inefficient process. A single transmission may have millions of packets. Incorporating teachings disclosed herein may allow a provider to increase communication bandwidth of a main high-speed data network without the need for additional infrastructure by removing and/or limiting the number of bundling and unbundling operations.

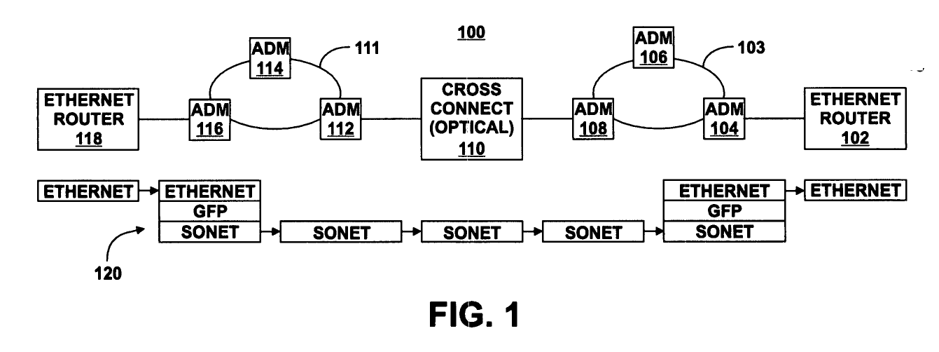

Referring to FIG. 1 a high volume communication system 100 is illustrated such as a communication system backbone having SONET's. The communication system 100 illustrated includes a first Ethernet router 118, and a plurality of add/drop multiplexers (ADM) such as first ADM 116, second ADM 114, and third ADM 116, which help create first SONET ring 111. As depicted, first SONET ring 111 is coupled to second SONET ring 103 by optical cross-connect 110 and ADM 108. Second SONET ring 103 includes fourth add/drop multiplexer (ADM) 104, fifth ADM 106, and sixth ADM 108, which are communicatively coupled to Ethernet router 102.

As data enters communication system 100, it may have a non-TDM format. For example, it may have a format other that a typical SONET time division multiplexing format. The data may, for example, have a format such as Ethernet, Fibre channel, Asynchronous Transfer Mode (ATM), or Internet Protocol (IP).

In one example, Ethernet data is received by Ethernet router 118 and is transmitted to first ADM 116. First ADM 116 may encapsulate the Ethernet data in SONET frames such as an STS-1 frame. The frames can be created utilizing a generic framing protocol (GFP), which helps bundle the Ethernet data into payloads within the STS frames. This exemplary process of protocol management/protocol conversion is illustrated by the protocol configuration blocks 120 depicted below the interconnect diagram of network 100, where a vertical progression of protocols indicates the protocol conversion occurring at a network component.

In one example, the STS-1 based data can be communicated around first SONET ring 111 until third ADM 112 receives instructions to route the data to second SONET ring 103. Third ADM 112 may transmit the non-TDM data encapsulated in an STS format to second SONET ring 103 via optical cross-connect 110. The encapsulated Ethernet data can then traverse the second SONET ring 103 and be received by fourth ADM 104 and sent to Ethernet router 102 based on SONET STS routing information.

Fourth ADM 104 may un-bundle the SONET STS-1 frame and place the data back into its original Ethernet format, and Ethernet router 102 utilizing GFR may provide an Ethernet format to route the information to the appropriate destination. The format or protocol that the data posses and the conversion the data undergoes while it moves within system 100 may be further understood by review of protocol conversion blocks 120.

Communication system 100 can move STS packets having non-TDM formatted data encapsulated as payload from first SONET ring 111 to second SONET ring 103 without the need to un-bundle and re-bundle at cross connects such as cross connect 110. If the STS format properly encapsulates the non-TDM data/protocol, cross connect 110 can utilize the STS routing information to move the encapsulated data from SONET system to SONET system without disassembling, unbundling, or un-encapsulating the data packets or data stream and accessing the routing information in the payload.

It is desirable when transporting the non-TDM traffic to reduce the number of translations as the data transverses from one SONET ring to another or from one network element to another. Mapping Ethernet data streams or frames into a GFP and eventually into a SONET STS-1 format at a SONET ADM may be at least partially accomplished in system 100 utilizing an Ethernet over SONET circuit card. Likewise, circuit cards may be available to process other non-TDM formats. Once mapped into the STS, the non-TDM formats may stay encapsulated within the STS-1 frame (as a SONET payload) until they exit the SONET system at a final ADM. Although only two SONET systems are illustrated, numerous SONET rings could be coupled utilizing optical cross-connect as STS based data is transmitted from one SONET ring to another.

Protocol encapsulation and de-encapsulation often utilizes extensive processing power or resources of an ADM. By minimizing the encapsulation and de-encapsulation of data, there may be considerable savings in terms of time and bandwidth. Minimizing the required processing routines allows more data to flow through an ADM and a SONET in a given time period without additional infrastructure. When the non-TDM data or frames stay encapsulated, the capacity of the processing resources can be increased because the SONET-to-GFP-to-Ethernet-to-GFP-to-SONET protocol encapsulation de-encapsulation betweens SONET rings is eliminated or reduced. Although the above illustration focuses on an Ethernet format, any format such as lose complying with the OSI model which are higher than layer 2, can also be encapsulated and have a seamless transmission or handoff between SONET systems.

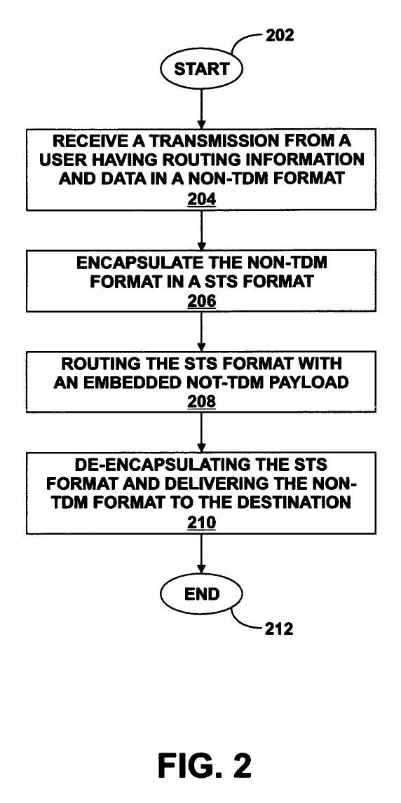

Referring to FIG. 2, a method of processing non-TDM formats is illustrated. The process starts at 202 and proceeds to step 204 where transmissions from a user having routing information and data in a non-TDM format is received. The non-TDM data is encapsulated into an STS-1 format at step 206. At step 208, the data is routed utilizing the STS format with a non-TDM data as a payload. The STS format can be transmitted over a multitude of SONET systems and de-encapsulated at a destination. The non-TDM format can be returned to its original package or format at the destination such as an Ethernet router at step 210, the process ends at 212.

By keeping the hand-off between two SONET rings at the STS level, CPU processing time on the SONET ADM is minimized since SONET “encapsulation and de-encapapsulation” of the payload is avoided until the traffic reaches its intended destination. This calls for a “dissimilar hand-off” architecture where in a single SONET ring, the customer traffic is receiving at a higher OSI layer (e.g. Ethernet, Fibre Channel or ATM) format and exits that SONET ring (handed off to the next ring) using an optical STS format (Layer 1 OSI model).

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system for transporting data comprising:
a first add delete multiplexer (ADM) configured to receive non Time Division Multiplexing (non-TDM) traffic and to encapsulate the non-TDM traffic within a SONET synchronous transport signal (STS) frame;
a first synchronous optical network (SONET) ring coupled to the first ADM; and
an optical cross connect module at least partially interconnecting the first SONET ring and a second SONET ring, the optical cross connect module configured to pass the SONET STS frame to the second SONET ring without de-encapsulating the non-TDM traffic from the SONET STS frame.

2. The system of claim 1 wherein the ADM can convert Protocols complying with OSI layers 3 and 4 into an STS format.

3. The system of claim 1, further comprising a second optical cross connect communicatively coupling the second SONET ring and a third SONET ring.

4. The system of claim 1 wherein the first ADM further comprises an Ethernet over SONET card.

5. The system of claim 1, wherein the non-TDM traffic element comprises an Ethernet frame.

6. The system of claim 1, wherein the non-TDM traffic element comprises an Internet Protocol packet.

7. The system of claim 1, wherein the non-TDM traffic element comprises an Asynchronous Transfer Mode (ATM) frame.

8. The system of claim 1, wherein the non-TDM traffic element comprises a Fibre channel frame.

9. The system of claim 1, wherein the SONET synchronous transport signal (STS) frame comprises a SONET synchronous transport signal level 1 (STS-1) frame.

10. The system of claim 1, further comprising an Ethernet switch communicatively coupled to the first ADM.

11. A method of transporting traffic with SONET rings, comprising:
transporting an Ethernet frame as an embedded payload within a SONET synchronous transport signal level 1 (STS-1) frame; and
maintaining the Ethernet frame as the embedded payload within the SONET STS-1 frame as the SONET STS-1 frame moves from a first SONET ring to a second SONET ring.

12. The method of claim 11, further comprising utilizing Generic Framing Protocol (GFP) to map the Ethernet frame into the SONET STS-1 frame.

13. The method of claim 11, further comprising utilizing an Ethernet over SONET card to encapsulate the Ethernet frame as the embedded payload.

14. The method of claim 11, further comprising moving the SONET STS-1 frame to the second SONET ring via an optical cross-connect.

15. The method of claim 11, further comprising:
identifying a SONET add-drop multiplexer (ADM) from which the Ethernet frame will pass to an Ethernet switch;
recognizing that the SONET STS-1 frame has reached the SONET ADM; and
unmapping the Ethernet frame from the SONET STS-1 frame.

16. The method of claim 11, further comprising maintaining a plurality of Ethernet frames as embedded payloads within a respective plurality of SONET STS-1 frames as the respective plurality of SONET STS-1 frame move from the first SONET ring to the second SONET ring.

17. The method of claim 11, further comprising maintaining the Ethernet frame as the embedded payload within the SONET STS-1 frame as the SONET STS-1 frame moves from the second SONET ring to a third SONET ring.

18. The method of claim 11, further comprising:
transporting a Fibre channel frame as an embedded payload within an other SONET synchronous transport signal level 1 (STS-1) frame; and
maintaining the Fibre channel frame as the embedded payload within the other SONET STS-1 frame as the other SONET STS-1 frame moves from the first SONET ring to the second SONET ring.

19. The method of claim 11, further comprising:
transporting an Asynchronous Transfer Mode (ATM) frame as an embedded payload within an other SONET synchronous transport signal level 1 (STS-1) frame; and
maintaining the ATM frame as the embedded payload within the other SONET STS-1 frame as the other SONET STS-1 frame moves from the first SONET ring to the second SONET ring.

20. The method of claim 11, further comprising:
transporting a non time division multiplexing (non-TDM) traffic element as an embedded payload within an other SONET synchronous transport signal level 1 (STS-1) frame; and
maintaining the non-TDM traffic element as the embedded payload within the other SONET STS-1 frame as the other SONET STS-1 frame moves from the first SONET ring to the second SONET ring.

21. A method of transporting non Time Division Multiplexing (non-TDM) traffic with SONET rings, comprising:
receiving a non-TDM traffic element at a first SONET ring;
transferring the non-TDM traffic element to a second SONET ring by interpreting the STS routing data; and
outputting the non-TDM traffic element as an embedded payload from the second SONET ring.

22. The method of claim 21, wherein the non-TDM traffic element comprises an Ethernet frame.

23. The method of claim 21, wherein the non-TDM traffic element comprises an Internet Protocol packet.

24. The method of claim 21, wherein the non-TDM traffic element comprises an Asynchronous Transfer Mode (ATM) frame.

25. The method of claim 21, wherein the non-TDM traffic element comprises a Fibre channel frame.

26. The method of claim 21, further comprising staying at a SONET layer at encountered interconnections between SONET rings.

27. The method of claim 26, wherein the encountered interconnections comprise optical cross-connects.
